(19) United States
(12) Patent Application Publication
(10) Pub. No.: US 2006/0140198 A1
(43) Pub. Date: Jun. 29, 2006

(54) Method and system for determining media gateway loading

(76) Inventors: Arif Majeed, Chandler, AZ (US); Donald M. Maschoff, Phoenix, AZ (US); Joseph C. Sligo, Chandler, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/022,168

(22) Filed: Dec. 23, 2004

(51) Int. Cl. H04L 1/00; H04J 3/14; H04J 1/16; H04L 12/56

(52) U.S. Cl. 370/401; 370/235

(57) ABSTRACT

A method for load balancing call traffic in a telecommunication gateway is disclosed. The communication gateway comprises a plurality of media gateway controllers and a plurality of media gateways. The media gateway controllers and the media gateways are coupled in a many-to-many relationship. In a first step of the method, a status request for a load level is sent from one of the plurality of media gateway controllers to each of the plurality of media gateways controlled by the one of the plurality of media gateway controllers. Next, a reply containing a load level is received from each of the plurality of media gateways. Then, a proper media gateway from the plurality of media gateways to route a call is determined based on the load level.

### TECHNICAL FIELD OF THE INVENTION

This invention relates to the field of telecommunications and, more specifically, to a method and system for determining media gateway loading.

### BACKGROUND OF THE INVENTION

In traditional telephony, when party A wants to speak with party B, party A dials party B's phone number. After the phone number is dialed, various telephone switches activate to establish a dedicated circuit between party A and party B. Party A and party B are then able to converse with each other. Until one party ends the conversation by hanging up the phone, the established circuit between the parties persists and the parties have exclusive use of that circuit. This process is known as circuit switching and, while providing a reliable method for communications, can be expensive because circuit switched telephony requires extensive switching facilities, and every connection requires a dedicated circuit for the duration of the conversation.

Different systems have been designed to move telephony away from traditional circuit switched networks. For example, one such system is voice over IP (VOIP). VOIP is a packet switched method of providing voice telephone calls. In a typical VOIP system, the conversations of party A and party B are digitized and divided into any number of data packets. Each packet is given a unique identifier and a destination address. These packets then travel through a data network, such as the Internet, to their destination, where the packets are reassembled. Then, the digitized voice is converted back to analog voice. The analog voice can then be routed through a circuit switched data network for final delivery of the call to the recipient.

To provide interoperability between circuit switched networks and packet switched networks, a gateway can be used. The gateway can include media gateways, which terminate media streams, such as analog voice streams, packetize the data, and deliver the packets of data to a data network, such as the Internet. Media gateways work under the control of media gateway controllers. One task of the media gateway controller is to properly load balance the media gateways. That is, the media gateway controller distributes calls amongst the various media gateways to ensure efficient use of resources. In prior art systems, each media gateway controller is associated with one or more media gateways in a one-to-many relationship. In this arrangement, the media gateway controller is able to assign calls in a balanced manner to one or more media gateways, since the media gateway controller has knowledge of the traffic allocated to each of the associated media gateways.

However, if multiple media gateway controllers assign calls to multiple media gateways; that is, if there is a many-to-many relationship between media gateway controllers and media gateways, a single media gateway controller does not have knowledge of all traffic assigned to a media gateway and, therefore, is unable to properly load balance incoming calls. What is needed is a method and system for determining media gateway loading.

### SUMMARY OF THE INVENTION

In one embodiment of the present invention, a method for load balancing call traffic in a telecommunication gateway is disclosed. The communication gateway comprises a plurality of media gateway controllers and a plurality of media gateways. The media gateway controllers and the media gateways are coupled in a many-to-many relationship. In a first step of the method, a status request for a load level is sent from one of the plurality of media gateway controllers to each of the plurality of media gateways controlled by the one of the plurality of media gateway controllers. Next, a reply containing a load level is received from each of the plurality of media gateways. Then, a proper media gateway from the plurality of media gateways to route a call is determined based on the load level.

In another embodiment of the present invention, a telecommunications gateway is disclosed. The telecommunication gateway comprises a plurality of media gateway controllers and a plurality of media gateways coupled to the media gateway controllers in a many-to-many relationship. In the embodiment, each of the plurality of media gateways are configured to send a load level reply to each a requesting media gateway controller.

### BRIEF DESCRIPTION OF THE DRAWINGS

The present invention will hereinafter be described in conjunction with the following drawing figures, wherein like numerals denote like elements, and:

FIG. 1 is a block diagram of a communication system in accordance with the teachings of the present invention;

FIG. 2 illustrates the relationship between media gateway controllers and media gateways in accordance with the teachings of the present invention;

FIG. 3 is a flowchart of an exemplary method of determining the load on a media gateway in accordance with the teachings of the present invention; and

FIG. 4 illustrates an exemplary command flow between a media gateway controller and a media gateway in accordance with the teachings of the present invention.

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical, background, brief summary or the following detailed description.

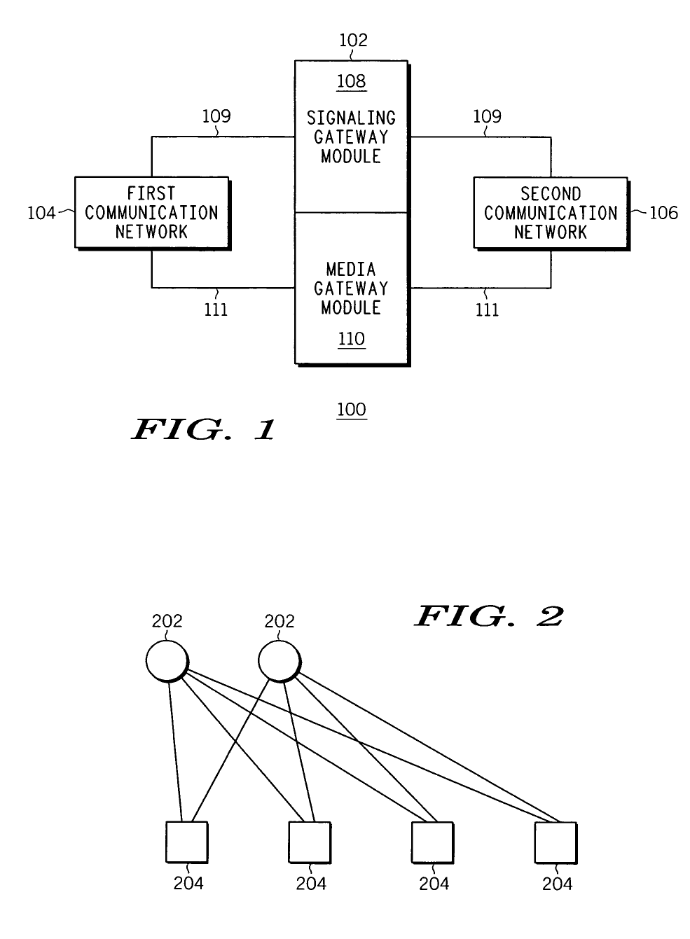

FIGS. 1-2 illustrate an exemplary communication system wherein multiple media gateway controllers assign calls to multiple media gateways. Calls can include the transfer of any type of data, including, but not limited to, voice data. As seen in FIG. 1, which is a block diagram of an exemplary communication system 100, a gateway 102 is coupled to a first communication network 104 and a second communication network 106.

First communication network 104 and second communication network 106 can be one of many types of communication networks including, but not limited to, cellular networks, computer data networks, plain-old-telephone (POTS) networks and the like. First communication network 104 and second communication network 106 can be incompatible networks or compatible networks. For example, first communication network 104 can be a network supporting voice over IP (VOIP) and second communication network 106 can be a circuit switched network.

Gateway 102 provides an entrance to and exit from a communication networks such as first communication network 104 and second communication network 106. In one embodiment, gateway 102 can connect incompatible networks. In this embodiment, the gateway 102 performs any needed code and protocol conversions to support incompatible networks. For example, gateway 102 can connect a public switched telephone network with a voice over IP network, a push-to-talk network, a data network and the like.

While gateway 102 is illustrated as a single device located at a single location, gateway 102 can be a physically decomposed gateway having its various components spread throughout a network. In one embodiment, gateway 102 can be part of the integrated enhanced network (iDEN).

In one embodiment, gateway 102 includes a signaling gateway module 108 and a data media gateway module 110. Signaling gateway module 108 includes one or more media gateway controllers 202 (FIG. 2). The media gateway controllers 202 receive signaling information via a signaling path 109 from calls originated at first communication network 104 and second communication network 106. The signal information can contain, among other information, call setup and call tear down information.

The data media gateway module 110 comprises one or more media gateways 204 (FIG. 2). Media gateways 204 can send and receive call data (which can be any information capable of being sent by a telecommunication network, including voice data) from first communication network 104 and second communication network 106 via a data path 111. In one embodiment, the media gateway 204 can packetize the received call data (if the call data is not already in packets), receive packet header address information from the media gateway controller 202 and deliver the packetized call data to the proper destination.

As seen in FIG. 2, media gateway controllers 202, in one embodiment, couple to two or more media gateways 204. The media gateway controllers 202 can direct call traffic to any one of the media gateways 204 under its control. As discussed previously, if media gateways 204 are coupled to a single media gateway controller 202, the balancing of call traffic amongst the media gateways 204 is trivial since the media gateway controller 202 knows at all times to which media gateway 204 call traffic is being sent.

As seen in FIG. 2, in the present invention multiple media gateway controllers 202 are coupled to each media gateway 204. Thus, while each media gateway controller 202 knows what calls it assigns to each media gateway 204, the media gateway controller 202 does not know what traffic has been assigned by other media gateway controllers 202. Without the knowledge of the total traffic assigned to each of the media gateways 202, the media gateway controllers 204 cannot effectively balance incoming call traffic between the media gateways 202.

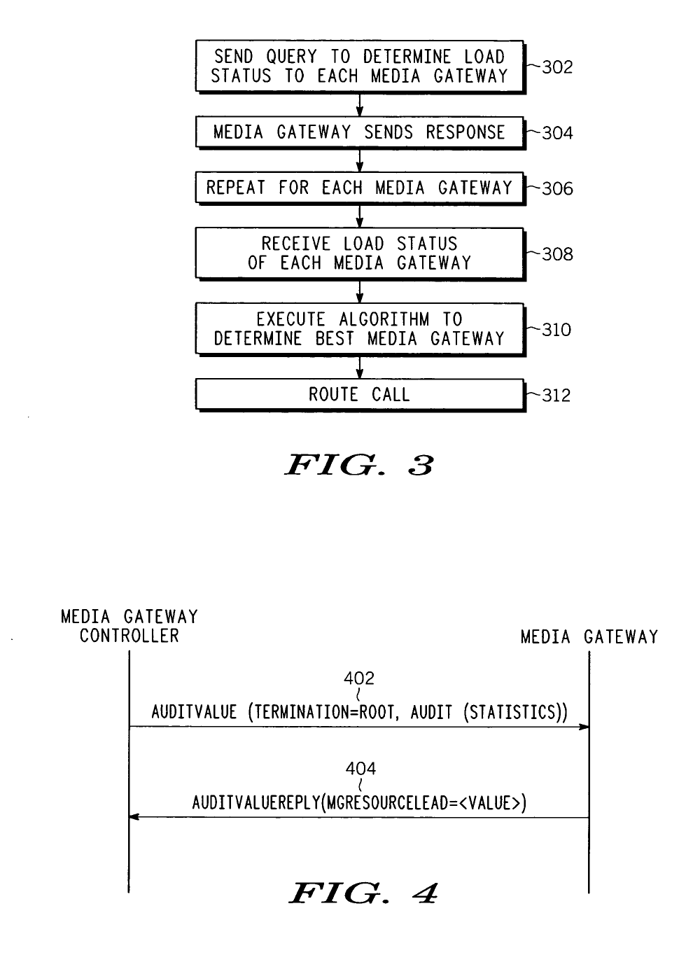

To solve this problem, in one embodiment of the present invention, each media gateway controller 202 can send a query to each media gateway 204 under its control, the query requesting the loading status of the media gateway 204. A method for determining the loading of media gateway 204 is illustrated in conjunction with FIGS. 3 and 4.

FIG. 3 is a flowchart illustrating an exemplary method of determining the loading of media gateways 204. In a first step, step 302, the media gateway controller 202 sends a query to each media gateway 204 under its control, the query requesting the loading status of each of the media gateways 204. This request can take many different forms, the form being determined, at least in part, by the communication protocol used for communications between the media gateway controller 202 and the media gateway 204.

In one embodiment of the present invention, the media gateway control (MEGACO) protocol is used. The MEGACO protocol is a low level protocol used in gateways. The MEGACO protocol does not include a command that can be used by the media gateway controller 202 to request loading status. Instead, media gateways 204 can request a back off in loading from each of the media gateway controllers 202. This places the loading algorithm responsibility on the media gateway 204. Because of the many-to-many relationship between the media gateway controller 202 and media gateway 204, the media gateway 204 has the difficult task of trying to determine how much each media gateway controller 202 needs to back off loading. Thus, current implementation of the MEGACO protocol does not allow for an efficient way to control loading of the media gateways 204. As a solution, in one embodiment of the present invention, the MEGACO protocol can be extended to allow for the media gateway 204 to respond to a request from the media gateway controller 202 with loading information.

As an example, FIG. 4 illustrates the call flow between the media gateway controller 202 and the media gateway 204. In the embodiment of the present invention, the media gateway controller 202 sends a status request 402 to the media gateway 204. As example status request 402 can be expressed in pseudo syntax as AuditValue (Termination=ROOT, Audit{Statistic}). The command syntax, AuditValue, is an existing MEGACO command. However, in the MEGACO protocol, the AuditValue command is typically used to retrieve the state of a call, the maximum number of calls, the maximum number of call terminations, the states of call terminations and other call statistics. It currently can not be used to retrieve loading information.

After receiving a request for loading information, in step 304, the media gateway 204 responds with loading information. In the embodiment where the MEGACO protocol is used, and as illustrated in FIG. 4, the media gateway 204 sends a reply 404 in response to the status request 402 with a value that represents a percent loaded for the media gateway 204. While a percent loaded can be requested, other measurements of the load of the media gateway 204 can also be requested. As seen in FIG. 4, an exemplary pseudo-syntax of the reply 404 can be AuditValueReply (MG ResourceLoading=<value>). The MGResourceLoading “=<value>” reply is not a part of the MEGACO protocol but can be added by the use of packages, which extend the MEGACO protocol and can be registered with the MEGACO protocol standards committee. The MEGACO protocol is an exemplary protocol used by gateways 102; other protocols can be used and adapted for use in the present invention.

Next, in step 306, steps 302 and 304 are repeated for each of the media gateways 204 controlled by the media gateway controller 202.

In step 308, the media gateway controller 202 receives call data requiring the assignment of a call to one of the media gateways 204. In step 310, the media gateway controller 202 executes an optimization algorithm that uses the loading information from each media gateway 204 and assigns the call to the proper media gateway 204. Such optimizing algorithms are well known in the art. In step 312, the call is routed to the media gateway 204 determined in step 308.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed:

1. A method for load balancing call traffic in a telecommunication gateway, the telecommunication gateway comprising a plurality of media gateway controllers and a plurality of media gateways, the media gateway controllers and the media gateways coupled in a many-to-many relationship, the method comprising:
sending a status request for a load level from one of the plurality of media gateway controllers to each of the plurality of media gateways controlled by the one of the plurality of media gateway controllers; and
receiving a reply containing a load level from each of the plurality of media gateways.

2. The method of claim 1 further comprising the step of determining a proper media gateway from the plurality of media gateways to route a call based on the load level.

3. The method of claim 1 wherein the step of sending a request comprises sending a protocol specific request to each of the media gateways.

4. The method of claim 3 wherein the step of receiving a load level comprises receiving a protocol specific reply from each of the media gateways.

5. The method of claim 4 wherein the step of sending a status request further comprises sending a request using the MEGACO protocol.

6. The method of claim 5 further comprising forming an extension to the MEGACO protocol to use for the reply.

7. A telecommunications gateway comprising:
a plurality of media gateway controllers; and
a plurality of media gateways coupled to the media gateway controllers in a many-to-many relationship, each of the plurality of media gateways configured to send a load level reply to each a requesting media gateway controller.

8. The gateway of claim 7 wherein the load level reply is a percent indication of the load on the media gateway.

9. The gateway of claim 8 wherein each of the plurality of media gateway controllers are operable to determine a proper media gateway to route call data based on the load level.

10. The gateway of claim 7 wherein each of the plurality of media gateway controllers and each of the plurality of media gateways communicate using the MEGACO protocol.

11. The gateway of claim 7 wherein the gateway couples a circuit switched network and a voice over IP network.

12. A method of using a media gateway controller to assign call traffic to a media gateway when the media gateway controller and the media gateway are coupled in a many-to-many relationship, the method comprising:
receiving call signaling information at the media gateway controller;
sending a request for loading status to each media gateway controlled by the media gateway controller;
receiving a reply of loading status from each media gateway; and
determining a proper media gateway to assign the handing of the call data using the loading status of each media gateway.

13. The method of claim 12 wherein the step of sending a request comprises sending a protocol compliant request from the media gateway controller to each of the media gateways controlled by the media gateway controller.

14. The method of claim 13 wherein the step of receiving a loading status comprises receiving a protocol specific reply from each media gateway.

15. The method of claim 14 wherein the step of receiving a loading status comprises receiving a protocol specific reply from each media gateway further comprises receiving a reply using the MEGACO protocol.

16. The method of claim 15 further comprising using an extension of the MEGACO protocol to form the reply of loading status.

17. A communication system comprising:
a first communication network;
a second communication network; and
a gateway coupling the first communication network to the second communication, the gateway comprising:
two or more media gateway controllers; and
two or more media gateways coupled to the media gateway controllers in a many-to-many relationship, each of the media gateways configured to send a load level indication to each of a requesting media gateway controller.

18. The system of claim 17 wherein the first communication network is a circuit switched network and the second communication network is a voice over IP network.

19. The system of claim 18 wherein the load level indication is a percent indication of the load on the media gateway.

20. The system of claim 17 wherein the media gateway controllers are operable to determine a proper media gateway to which to route call data based on the load level.

21. The system of claim 18 wherein the media gateway controllers and the media gateways communicate using the MEGACO protocol.
